(19) United States
(12) Patent Application Publication
(10) Pub. No.: US 2003/0152896 A1
(43) Pub. Date: Aug. 14, 2003

(54) Toilet training kit

(76) Inventor: Caroline Hudson, Essex (GB)

Correspondence Address: Rodney L Skoglund, Renner Kenner Greive Bobak, Taylor & Weber, 1610 First National Tower, Akron, OH, 44308, US

(21) Appl. No.: 10/332,867

(22) PCT Filed: Jul. 13, 2001
(86) PCT No.: PCT/GB01/03175

(30) Foreign Application Priority Data
Jul. 13, 2000 (GB) 0017280.9

(51) Int. Cl. G09B 19/00

(52) U.S. Cl. 434/258

(57) ABSTRACT

A kit of parts for use in potty training an infant, comprising: a plurality of sheets of toilet tissue carrying images and preferably on a roll (14); a plurality of training cards (30, 31, 32, 33, 34, 35) each carrying one of a sequence of pictures, the sequence illustrating an infant during different the stages of using a potty and then being rewarded with a badge; and a badge (20) or badges incorporating means, such as glue, to affix the badge to an item of clothing. The kit may be contained in a dispenser box (10) which may serve as a dispenser and storage container. The consumable items of the kit such as the toilet tissue and reward badges may be replaced as appropriate, particularly from a refill pack comprising a roll of toilet tissue (14) and a sheet (19) of self-adhesive badges.

This invention relates to a kit of parts for use in potty and toilet training of an infant or young child.

Potty training is an important development stage that young children and parents encounter. In some instances, it can pass relatively smoothly but for the majority it presents new and difficult problems and more often than not can cause psychological fears that may continue for several months. Potties are available in various shapes and sizes, but how does one explain to an infant the purpose thereof and the method for using them?

In order to alleviate the difficulties associated with toilet training and assist both parents and children, it is an aim of the present invention to provide the means to aid in the toilet training of infants.

According to the present invention there is provided a kit of parts for use in toilet training an infant or young child, comprising:

a plurality of sheets of toilet tissue;

a plurality of training cards each carrying one of a sequence of pictures, the sequence illustrating an infant or young child using a potty and being rewarded with a badge; and

a badge or badges incorporating means to affix the badge or badges to an item of clothing.

It is preferred that the pictures on the training cards comprise separate sequential images that may be displayed to the infant during the process of training as a prompt and memory aid. Preferably six images are used, and they illustrate: an infant drinking, an infant sitting on the potty, an infant using toilet tissue to wipe its bottom, an infant discarding the paper in the potty, an infant washing its hands, and an infant being rewarded with a badge.

It is highly preferred that the kit also includes a dispenser box for containing the toilet tissue so that in use the toilet tissue may be dispensed therefrom. The remaining components of the kit may also be packaged with or within the dispenser box. It is preferred that images corresponding to those on the training cards are also printed on the dispenser box.

It is preferred that the sheets of toilet tissue are provided with decoration as this may both amuse the infant and increase the visual appeal of the tissue. This decoration may take any suitable form but preferable has various character themes. For example the themes might include Potty People, Potty Pets, Potty Playtime, and Potty Playthings. The toilet tissue is preferably provided in the form of a roll, with individual sheets of tissue joined end to end and separated by perforations. As the toilet tissue is intended for use by infants it is preferred that a roll thereof is of reduced dimensions as compared to a conventional roll of toilet tissue.

The reward badge or badges are preferably self-adhesive stickers, which are provided on a peelable backing sheet. Once an infant has completed the appropriate task a badge may be peeled from the backing and affixed to the clothing of the infant. Such self adhesive badges may not be reused so it is preferred that a plurality of such badges are provided on one or a number of backing sheets.

Various items in the kit, such as the toilet tissue and the self-adhesive badges, are used up during potty training. It is preferred that such consumable items may be replenished as appropriate. Preferably the dispenser box may be refilled with toilet tissue and further badges or sheets of badges may be provided.

The dispenser box may be provided with retaining means to hold the badge or badges and the training cards when they are not in use. As the training cards and badges are generally planar, the retaining means may comprise tabs projecting from a surface of the dispenser box and lying approximately parallel thereto such that the training cards and/or sheets of badges may be located between the tabs and the surface of the dispenser box. Such a tab may conveniently be formed by cutting a v-shaped (or other suitable shape) slit in the material of the dispenser box and distorting the thus defined tab slightly out of the plane of the remaining material.

The dispenser box may be provided with a lid, the opening of which permits access to the toilet tissue and to other parts of the kit temporarily stored therewith. Such a lid might extend over a surface of the box that is provide with tabs as mentioned above and thus ensure that the articles retained by the tabs are prevented from coming free.

One specific embodiment of the present invention will now be described by way of example with reference to the accompanying drawings in which:

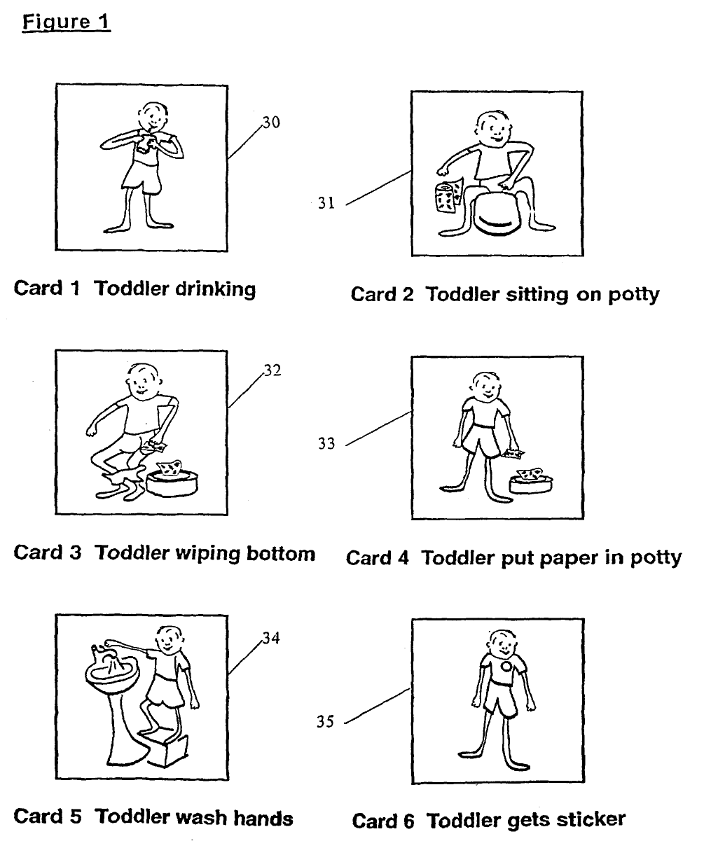

FIG. 1 shows six training cards, each carrying a picture in a sequence of pictures;

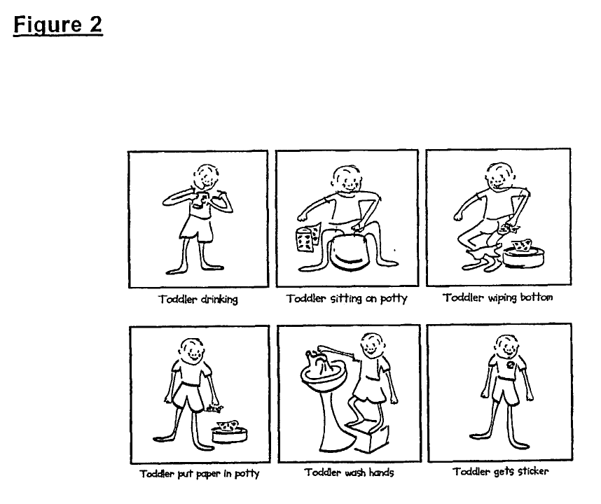

FIG. 2 illustrates a reduced size composite version of those images which are printed on the lid of the dispenser box;

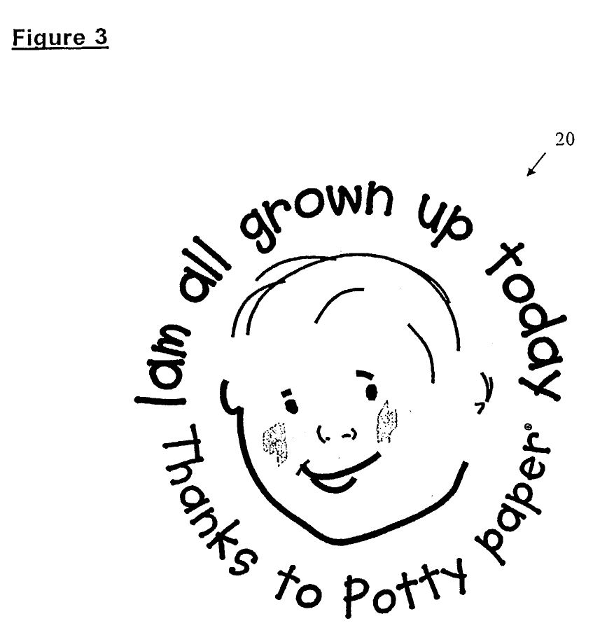

FIG. 3 shows a reward sticker;

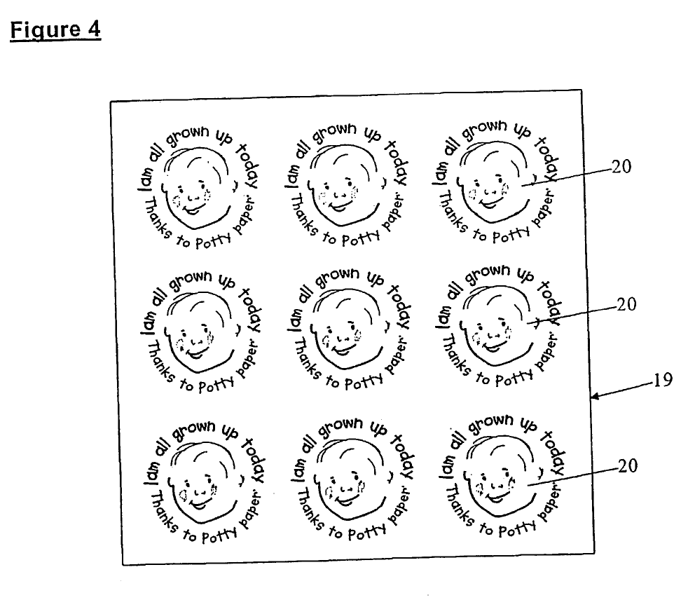

FIG. 4 illustrates a sheet of self-adhesive reward stickers;

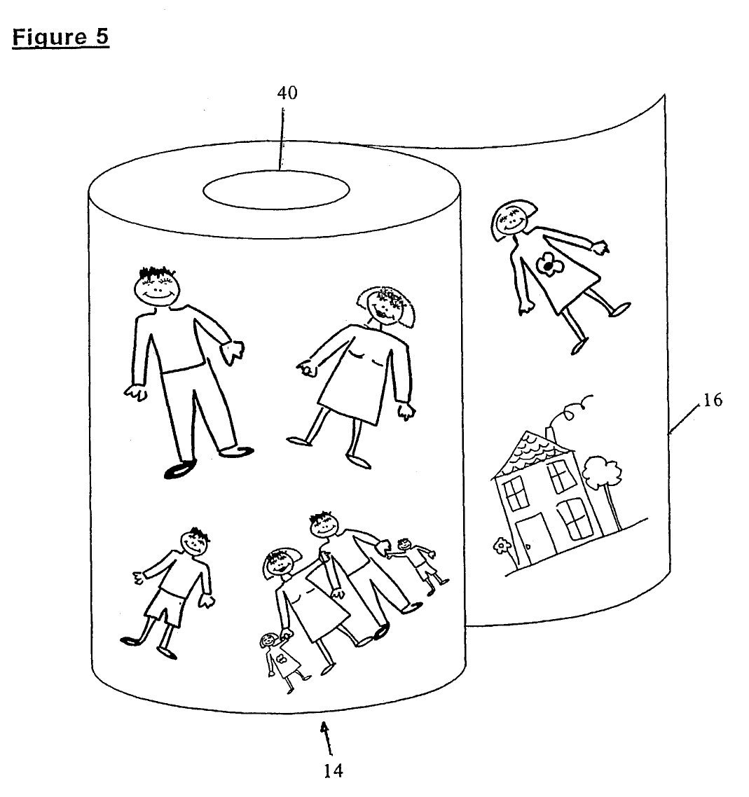

FIG. 5 shows a series of decorated sheets of toilet tissue wound into a roll; and

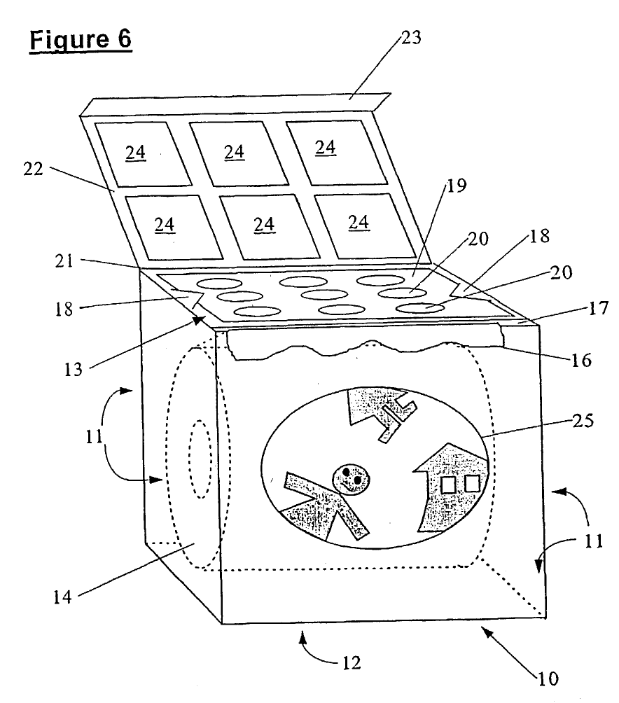

FIG. 6 illustrates a dispenser box with a roll of toilet tissue therein.

Referring initially to FIG. 6, there is shown a dispenser box generally indicated 10. The box is generally cubic with four side walls 11, an openable base wall 12 and a top wall 13. A roll 14 of sheets of toilet tissue bearing decorations is contained within the box 10 and is able to rotate therein such that the free end 16 of the roll may be drawn from the box to dispense sheets. A serrated opening 17 is provided at the edge of the top wall 13 and the toilet tissue may be dispensed therethrough, with the serrations (not shown) aiding the separation of sheets from the roll 14.

The top wall 13 is provided with opposed retaining tabs 18 that are generally parallel with the top wall 13. When not in use, a sheet 19 carrying several reward stickers 20 (which are better shown and described with reference to FIGS. 3 and 4) may be stored against the top wall 13 by locating the edges of the sheet 19 of stickers 20 under the tabs 18. Training cards, (not shown in this figure, but shown in FIG. 1) may also be retained against the top wall 13 by the tabs 18 in a similar way.

A lid 22 is hingedly connected to the top wall 13 along the edge 21 opposed to the opening 17, and a tongue 23 is connected to the lid 18. When the lid 18 is closed against the top wall 13 the tongue 23 locates in the opening 17 to hold the lid shut. The closure of the lid 22 also prevents toilet tissue from being dispensed and the sticker sheets 19 or training cards from coming from their stored positions under the tabs 18.

A series of images 24 as shown in FIG. 2 are printed on the underside of the lid 22 so that they are visible to a user when the lid is opened. The side wall 11 adjacent the opening 17 is provided with an acetate viewing window 25 through which the roll 14 may be viewed. When the roll is finished the spent roll may be removed and a replacement may be inserted by opening the bottom wall 12.

FIG. 1 shows a series of six training cards which are shown to the infant during the process of using the potty. The cards act as a prompt and memory aid to the children as well as helping them understand the tasks required and the order in which they should be performed. The first card 30 shows an infant drinking. The second card 31 shows an infant sitting on a potty. The third card 32 shows the infant wiping its bottom with toilet tissue. The image on the fourth card 33 shows the infant discarding the used toilet tissue into the potty. On the fifth card 34 the image shows the infant washing its hands. Finally, on the sixth card 35 the infant is shown receiving a reward in the form of a badge (in practise a self-adhesive sticker).

FIG. 2 shows the arrangement of images 24 as displayed on the lid 22 of the dispenser box 10. These are reduced size facsimile images of those shown on the cards 30, 31, 32, 33, 34 and 35.

FIG. 3 shows a single reward badge in the form of a self adhesive sticker 20. The image on the sticker shows a smiling child with the wording “I am all grown up today thanks to Potty Paper” printed therearound. FIG. 4 shows a sheet 19 of nine self-adhesive stickers 20 on a release layer. When required individual stickers 20 may be peeled one at a time from the release layer and given to an infant as a reward for following the correct toilet procedure.

A roll 14 of toilet tissue is shown in FIG. 5. The roll comprises a series of sheets of toilet tissue joined end to end and wound into a roll around a disposable tube 40. The roll may be unwound from the free end 16.

As used herein the terms potty refers to specially designed infant toilets. However, whilst reference is made to “potty training” and whilst toilet training is often carried out using potties rather than conventional toilets, it will be appreciated that the process of training may still be carried out on conventional toilets, and the present invention is equally applicable thereto.

1. A kit of parts for use in potty and toilet training an infant or young child, comprising:
a plurality of sheets of toilet tissue;
a plurality of training cards each carrying one of a sequence of pictures, the sequence illustrating an infant or young child using a potty and being rewarded with a badge; and
a badge or badges incorporating means to affix the badge or badges to an item of clothing.

2. A kit of parts as claimed in claim 1 wherein the sequence of pictures on the training cards comprise separate images of: an infant or young child drinking, an infant or young child sitting on the potty, an infant or young child using toilet tissue and wiping its bottom, an infant or young child putting paper in the potty, an infant or young child washing hands, and an infant or young child being rewarded with a badge.

3. A kit of parts as claimed in claim 1 or claim 2, wherein the kit also includes a dispenser box for containing the toilet tissue and from which the toilet tissue may be dispensed and in which or with which the remaining components of the kit are packaged.

4. A kit of parts as claimed in claim 3, wherein the dispenser box is provided with locating means to hold the badge or badges and the training cards when not in use.

5. A kit of parts as claimed in claim 3 or claim 4, wherein the dispenser box is refillable with toilet tissue and/or badges.

6. A kit of parts as claimed in any of claims 3 to claim 5, in which the dispenser box has a lid, which in its open position permits access to the toilet tissue, training cards and badge or badges so that the kit may be used.

7. A kit of parts as claimed in any of claims 3 to claim 6, in which images corresponding to those on the training cards are printed on the dispenser box.

8. A kit of parts as claimed in any of the preceding claims, wherein the plurality of sheets of toilet tissue are joined by perforations and are wound into a roll.

9. A kit of parts as claimed in any of claims 3 to claim 7, in which the dispenser box defines a toilet tissue holding space dimensioned such that a conventional roll of domestic toilet tissue cannot be located therewithin.

10. A kit of parts as claimed in claim 9, in which the plurality of sheets of the toilet tissue are joined by perforations and are wound into a roll, the dimensions of the roll being such that it may be located in the toilet tissue holding space of the dispenser box.

11. A kit of parts as claimed in any of the preceding claims, which includes a plurality of self-adhesive badges provided on a backing sheet.

12. A kit of parts as claimed in any of the preceding claims, in which the sheets of toilet tissue are decorated with images.
